(19) United States
(12) Patent Application Publication
(10) Pub. No.: US 2016/0189160 A1
(43) Pub. Date: Jun. 30, 2016

(54) SYSTEM AND METHOD FOR DEANONYMIZATION OF DIGITAL CURRENCY USERS

(71) Applicant: Verint Systems Ltd., Herzliya Pituach (IL)

(72) Inventor: Ziv Katzir, Netanya (IL)

(21) Appl. No.: 14/980,811

(22) Filed: Dec. 28, 2015

(30) Foreign Application Priority Data
Dec. 30, 2014 (IL) 236520

(51) Int. Cl. G06Q 20/40

(52) U.S. Cl. CPC G06Q 20/4014

(57) ABSTRACT

Methods and systems for deanonymizing digital currency users and transactions. The deanonymization system monitors communication sessions that are conducted in a communication network. From among the monitored sessions, the system detects sessions in which users carry out digital currency transactions. Having detected such a session, the system attempts to deanonymize the user, i.e., to correlate the digital currency pseudonym given in the session with some other information that is indicative of the user. The system may determined the identity of the terminal on which the user conducts the session, and uses the identity of the terminal to establish a correlation between the pseudonym and the user. In some cases the terminal is known to belong to a specific user.

### FIELD OF THE DISCLOSURE

The present disclosure relates generally to digital currency, and particularly to methods and systems for deanonymization of digital currency users.

### BACKGROUND OF THE DISCLOSURE

Various digital currencies, or digital cash systems, have been proposed as an alternative to conventional currency. One prominent example is Bitcoin. The Bitcoin system was first presented by Nakamoto, in “Bitcion: A Peer-to-Peer Electronic Cash System,” 2008, which is incorporated herein by reference. One of the design goals of digital currency systems is anonymity of users and transactions. In the Bitcoin system, for example, users are identified by hashed values of their public cryptographic keys, referred to as pseudonyms.

Several techniques for Bitcoin deanonymization have been published. Example techniques are described by Meiklejohn et al., in “A Fistful of Bitcoins: Characterizing Payments Among Men with No Names,” Proceedings of the 2013 conference on Internet Measurement Conference, Oct. 23-25, 2013, which is incorporated herein by reference. As another example, Biryukov et al. suggest a method for linking Bitcoin user pseudonyms to the IP addresses where the transactions are generated, in “Deanonymization of Clients in Bitcoin P2P Network,” arXiv:1405.7418v3 [cs.CR], Jul. 5, 2014, which is incorporated herein by reference.

### SUMMARY OF THE DISCLOSURE

An embodiment that is described herein provides a method including monitoring communication sessions in a communication network. A communication session, which relates to a transaction in a digital currency system and which includes a pseudonym used by a user to carry out the transaction in the digital currency system, is detected. A communication terminal conducting the communication session is identified, and a correlation is established between the pseudonym and the user based on identification of the terminal.

In some embodiments, identifying the terminal includes extracting an identifier of the terminal from the communication session, and establishing the correlation includes determining an identity of the user from the identifier. In an embodiment, identifying the terminal includes obtaining from the communication network an authenticating identifier used for authenticating the terminal, and establishing the correlation includes determining an identity of the user from the authentication identifier.

In another embodiment, identifying the terminal includes determining a geographical location of the terminal, and establishing the correlation includes determining an identity of the user from the geographical location. In yet another embodiment, establishing the correlation includes accumulating the correlation over multiple communication sessions in which the pseudonym appears.

In some embodiments, establishing the correlation includes correlating the terminal with a previous pseudonym that was used in a previous transaction that is linked to the transaction relating to the communication session. In an example embodiment, the previous pseudonym is obtained by querying a public record of transaction chains of the digital currency system.

There is additionally provided, in accordance with an embodiment that is described herein, a system including an interface and a processor. The interface is configured to monitor communication sessions in a communication network. The processor is configured to detect a communication session that relates to a transaction in a digital currency system and that includes a pseudonym used by a user to carry out the transaction in the digital currency system, to identify a communication terminal conducting the communication session, and to determine an identity of the user by correlating the wireless communication terminal with the pseudonym.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a bitcoin deanonymization system, in accordance with an embodiment that is described herein; and

FIG. 2 is a flow chart that schematically illustrates a method for correlating bitcoin pseudonyms with users, in accordance with an embodiment that is described herein.

### DETAILED DESCRIPTION OF EMBODIMENTS

### Overview

Embodiments that are described herein provide improved methods and systems for deanonymizing digital currency users and transactions. The embodiments described herein refer mainly to the Bitcoin system, but the disclosed techniques are also applicable in other digital currency schemes.

In some embodiments, a deanonymization system monitors communication sessions that are conducted in a communication network. The embodiments described herein refer mainly to wireless networks in which monitoring may involve off-air monitoring of the air interface, and/or monitoring of one or more suitable wired interfaces in the network. Alternatively, however, the disclosed techniques can be used in various wired networks, as well.

From among the monitored sessions, the system detects sessions in which users carry out Bitcoin transactions. Having detected such a session, the system attempts to deanonymize the user, i.e., to correlate the Bitcoin pseudonym given in the session with some other information that is indicative of the user. In some embodiments, the system determines the identity of the terminal (e.g., mobile phone or desktop computer) using which the user conducts the session, and uses the identity of the terminal to establish a correlation between the pseudonym and the user.

In some cases the terminal (e.g., mobile phone) is known to belong to a specific human user. In this case, correlating the Bitcoin pseudonym with the terminal is equivalent to correlating the Bitcoin pseudonym with the user. In other scenarios, such as in NAT or home-network environments, identifying the terminal may not provide a positive indication of a single specific user. In these scenarios, the system may accumulate several correlations that involve the same Bitcoin pseudonym in different locations or at different times, in order to narrow-down the correlation to a single user.

In some embodiments, after extracting a Bitcoin pseudonym from a communication session, the system scans the publically-available chain of Bitcoin transactions that led to the monitored transaction. The system extracts one or more other pseudonyms that were used in previous transactions in the chain. Such pseudonyms may belong to the same user who conducted the monitored session, or to individuals associated with that user. As such, establishing correlations with these additional pseudonyms may be valuable, as well.

### System Description

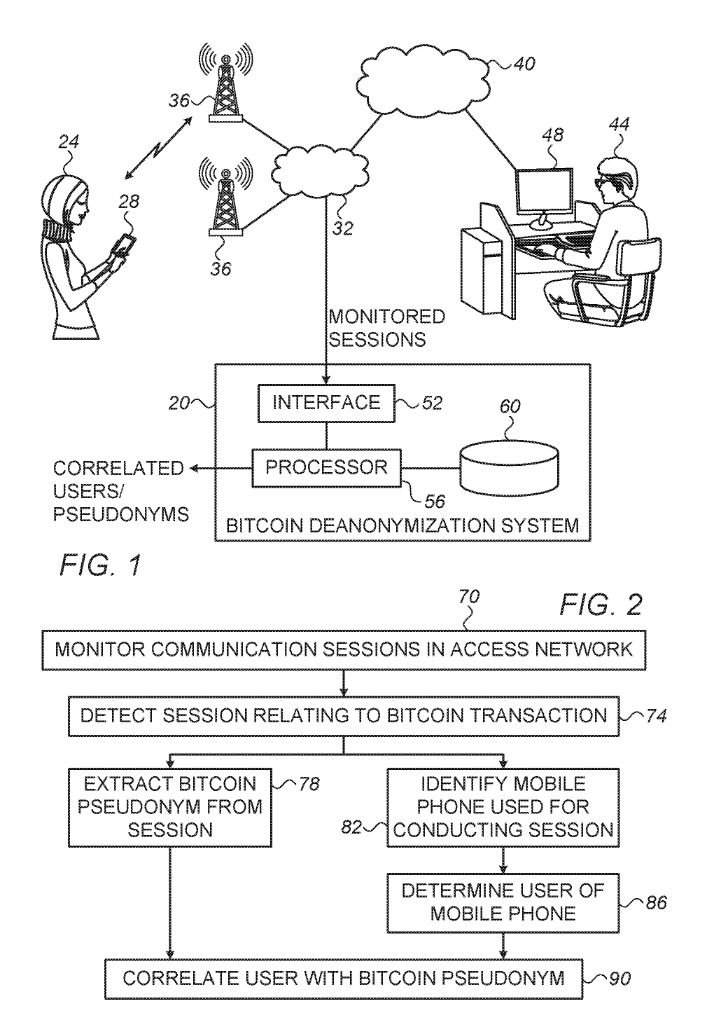

FIG. 1 is a block diagram that schematically illustrates a bitcoin deanonymization system 20, in accordance with an embodiment that is described herein. System 20 monitors communication sessions that are conducted by users 24 of communication terminals 28 in a communication network 32. The system detects sessions relating to Bitcoin transactions, and uses them to deanonymize the Bitcoin pseudonyms used in the transactions.

In some embodiments, network 32 may comprise a wireless network, such as a cellular telephony network (e.g., a GSM, UMTS or LTE network) or a Wireless Local-Area Network (WLAN). In such embodiments, terminals 28 may comprise, for example, mobile phones, wireless-enabled computing devices, or any other suitable type of wireless device. Terminals 28 typically conduct communication sessions in network 32 by communicating with base stations 36. The description that follows refers mainly to wireless networks. In alternative embodiments, however, network 32 may comprise a wireline network, in which case terminals 28 comprise devices such as desktop computers or Voice over IP (VoIP) phones. The figure shows a single user and a single terminal for the sake of simplicity. Real-life networks typically comprise a large number of users and terminals of various kinds.

Users 24 of wireless network 32 may communicate with one another or with users of other networks. In the present example, wireless network 32 is connected to a Wide-Area Network 40, such as the Internet, and users 24 may also communicate with wired users 44 who use wired terminals 48. In this context, network 32 is regarded as an access network, via which users 24 access the Internet or other large-scale network.

Users 24 may use terminals 28 to conduct various kinds of communication sessions. In particular, in some of the sessions users 24 may carry out Bitcoin transactions, e.g., pay or accept payments using Bitcoins. As will be described in detail below, deanonymization system 20 analyzes such sessions and attempts to correlate the Bitcoin pseudonyms used in the sessions with human users.

In the present example, system 20 comprises an interface 52 for monitoring communication sessions in network 32, a processor 56 that carries out the correlation methods described herein, and a database 60 that is used for storing the correlation or other information.

The configuration of system 20 shown in FIG. 1 is an example configuration that is chosen purely for the sake of conceptual clarity. In alternative embodiments, any other suitable system configuration can be used. For example, in some embodiments combines the disclosed deanonymization techniques with blacklists of Bitcoin pseudonyms. As another example, in some embodiments combines the disclosed deanonymization techniques with an alert engine that issues alerts in response to suspicious Bitcoin transactions.

Certain elements of system 20 can be implemented using hardware, such as using one or more Application-Specific Integrated Circuits (ASICs), Field-Programmable Gate Arrays (FPGAs) or other device types. Additionally or alternatively, certain elements of system 20 can be implemented using software, or using a combination of hardware and software elements. Database 60 may be implemented using any suitable memory or storage device, e.g., HDD, SSD or other non-volatile storage medium, and/or a suitable volatile memory such as Random Access Memory (RAM).

Typically, processor 56 comprises one or more general-purpose processors, which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Bitcoin Pseudonym Deanonymization Using Correlation with Wireless Terminals

The Bitcoin system aims to maintain the anonymity of its users. For the sake of anonymity, as well as security, Bitcoin users are identified in Bitcoin transactions using pseudonyms. A pseudonym comprises a hash value that is computed over a public cryptographic key of the user. Pseudonyms are also referred to as Bitcoin addresses.

In some applications it is desirable to deanonymize a Bitcoin pseudonym, e.g., to identify the human individual who stands behind the pseudonym. Deanonymization may be used, for example, by law enforcement agencies for tracking illegal transactions performed using the Bitcoin system. Such illegal transactions may relate to fraud, money laundering, trading of illicit goods or smuggling, to name just a few examples. In some embodiments, system 20 performs deanonymization by correlating Bitcoin pseudonyms with information on wireless terminals 28 obtained from network 32.

FIG. 2 is a flow chart that schematically illustrates a method for correlating bitcoin pseudonyms with users, in accordance with an embodiment that is described herein. The method begins with system 20 monitoring communication sessions in wireless network 32 using interface 52, at a monitoring step 70.

In some embodiments, monitoring is performed off-air, in which case interface 52 comprises a suitable wireless receiver for receiving and decoding the air interface between terminals 24 and base stations 36. Additionally or alternatively, system 20 may monitor one or more of the wireline interfaces between network-side nodes of network 32. In such embodiments, interface 52 may comprise a suitable network probe. A network probe would also be used, for example, when network 32 comprises a wired network.

At a transaction detection step 74, processor 56 detects in the monitored sessions a communication session relating to a Bitcoin transaction. Typically, the session involves some user 24 paying or receiving payment in Bitcoins.

Processor 56 identifies and extracts the Bitcoin pseudonym that the user gives in the transaction, at a pseudonym extraction step 78. Additionally, processor 56 identifies the terminal 28 (e.g., mobile phone) used for conducting the session, at a terminal identification step 82, and deduces the identity of the user from the identity of the terminal, at a user identification step 86.

At a correlation step 90, processor 56 correlates the user (determined at step 86) with the Bitcoin pseudonym (extracted at step 78). System 20 may present the deanonymization result (correlation between user and pseudonym) to an operator, store the result in database 60, or take any other suitable action.

The method of FIG. 2 may be carried out in a target-centric manner, i.e., applied to specific target pseudonyms that are of interest. Additionally or alternatively, the method of FIG. 2 may be carried out on a mass scale, e.g., on every detected session that involves a Bitcoin transaction.

In various embodiments, processor 56 may identify the terminal and the user from the monitored session in different ways. For example, processor 56 may extract from the monitored session an identifier of the terminal, and deduce the user identity from the identifier.

Identifiers that can be used for this purpose may comprise, for example, International Mobile Station Identity (IMSI), Mobile Station International Subscriber Directory Number (MSISDN), Internet Protocol (IP) address, Medium Access Control (MAC) address, or any other suitable identifier. The connection between terminal identifier and user identity can be obtained, for example, from a database of the wireless system service provider.

Another type of identifier that can be used for deanonymization is an authentication identifier used for authenticating the terminal when attempting to access the network. An authentication identifier may comprise, for example, a Remote Authentication Dial-In User Service Identifier (RADIUS ID). Processor 56 may obtain the RADIUS ID associated with a certain terminal, for example, by communicating with an Authentication, Authorization, and Accounting (AAA) server of network 32.

In some embodiments, processor 56 establishes the correlation between the pseudonym and the user based on geographical location. In a typical embodiment, processor 56 obtains from the monitored session an indication of the geographical location of the terminal conducting the session, and uses this geographical location to identify the user. The geographical location of the terminal can be estimated, for example, from the identity of the cell (CELL_ID) in which the terminal communicates, from GPS coordinates transmitted as part of the session, or in any other suitable way.

In some cases, identifying the wireless terminal in a single session does not provide an unambiguous identification of a single specific user. For example, when the terminal operates behind a Network Address Translation (NAT) device or in a home network, it may only be possible to associate the pseudonym with a group of users and not a single user.

Thus, in some embodiments, processor 56 establishes the correlation between the pseudonym and a single user by accumulating multiple correlations over multiple sessions in which the pseudonym appears. Such sessions may occur at different times and/or different locations, and therefore increase the confidence of linking the pseudonym to a single user.

In some embodiments, processor 56 uses the fact that Bitcoin transactions are linked to one another in chains of transactions, and that the records of these transaction chains is publically available. In these embodiments, after extracting the Bitcoin pseudonym from the monitored communication session, processor 56 scans the chain of Bitcoin transactions that led to the transaction appearing in the monitored session, and extracts one or more other pseudonyms that were used in previous transactions in the chain.

Such previous pseudonyms may belong to the same user who conducted the monitored session, or to individuals associated with that user. In either case, establishing correlations with these additional pseudonyms may be valuable, as well. In some cases it may be easier for processor 56 to correlate the terminal with some previous pseudonym, rather than with the pseudonym appearing in the session.

Consider, for example, a BitCoin transaction that has multiple inputs. When multiple different BitCoin pseudonyms are used as input to a given transaction, processor 56 can deduce with very high probability that both pseudonyms belong, or are controlled by, a single user. Using this heuristic, processor 56 can correlate and cluster together multiple BitCoin pseudonyms. Once such clusters have been constructed, it is enough for processor 56 to associate one pseudonym in a cluster with a communication terminal in order to associate all pseudonyms in the cluster to the same user.

It will be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

I/We claim:

1. A method, comprising:
monitoring communication sessions in a communication network;
detecting a communication session, which relates to a transaction in a digital currency system and which comprises a pseudonym used by a user to carry out the transaction in the digital currency system;
identifying a communication terminal conducting the communication session, and establishing a correlation between the pseudonym and the user based on identification of the terminal.

2. The method according to claim 1, wherein identifying the terminal comprises extracting an identifier of the terminal from the communication session, and wherein establishing the correlation comprises determining an identity of the user from the identifier.

3. The method according to claim 1, wherein identifying the terminal comprises obtaining from the communication network an authenticating identifier used for authenticating the terminal, and wherein establishing the correlation comprises determining an identity of the user from the authentication identifier.

4. The method according to claim 1, wherein identifying the terminal comprises determining a geographical location of the terminal, and wherein establishing the correlation comprises determining an identity of the user from the geographical location.

5. The method according to claim 1, wherein establishing the correlation comprises accumulating the correlation over multiple communication sessions in which the pseudonym appears.

6. The method according to claim 1, wherein establishing the correlation comprises correlating the terminal with a previous pseudonym that was used in a previous transaction that is linked to the transaction relating to the communication session.

7. The method according to claim 6, and comprising obtaining the previous pseudonym by querying a public record of transaction chains of the digital currency system.

8. A system, comprising:
an interface, which is configured to monitor communication sessions in a communication network; and
a processor, which is configured to detect a communication session that relates to a transaction in a digital currency system and that comprises a pseudonym used by a user to carry out the transaction in the digital currency system, to identify a communication terminal conducting the communication session, and to determine an identity of the user by correlating the wireless communication terminal with the pseudonym.

9. The system according to claim 8, wherein the processor is configured to extract an identifier of the terminal from the communication session, and to determine an identity of the user from the identifier.

10. The system according to claim 8, wherein the processor is configured to obtain from the communication network an authenticating identifier used for authenticating the terminal, and to determine an identity of the user from the authentication identifier.

11. The system according to claim 8, wherein the processor is configured to determine a geographical location of the terminal, and to determine an identity of the user from the geographical location.

12. The system according to claim 8, wherein the processor is configured to accumulate the correlation over multiple communication sessions in which the pseudonym appears.

13. The system according to claim 8, wherein the processor is configured to correlate the terminal with a previous pseudonym that was used in a previous transaction that is linked to the transaction relating to the communication session.

14. The system according to claim 13, wherein the processor is configured to obtain the previous pseudonym by querying a public record of transaction chains of the digital currency system.
